(19) United States
(12) Patent Application Publication
(10) Pub. No.: US 2008/0269053 A1
(43) Pub. Date: Oct. 30, 2008

(54) Amino Acid Compositions and Methods of Using as Fertilizer

(76) Inventors: John F. Less, Forsyth, IL (US); William Torello, S. Deerfield, MA (US)

Correspondence Address: ARCHER DANIELS MIDLAND COMPANY, 4666 FARIES PARKWAY, DECATUR, IL, 62526, US

(21) Appl. No.: 12/110,603

(22) Filed: Apr. 28, 2008

Related U.S. Application Data
(60) Provisional application No. 60/914,154, filed on Apr. 26, 2007.

(51) Int. Cl. A01N 37/36; C05C 11/00; A01P 13/00; A01P 21/00

(52) U.S. Cl. 504/101; 504/143; 71/11

(57) ABSTRACT

Compositions including an amino acid product, and uses thereof as fertilizers are disclosed.

### CROSS REFERENCE TO RELATED APPLICATIONS

This application claims the benefit of U.S. Provisional Application No. 60/914,154, filed Apr. 26, 2007, the contents of the entirety of which are incorporated by this reference.

### TECHNICAL FIELD

Various non-limiting embodiments of the present disclosure are directed toward a fertilizer comprising an amino acid. Non-limiting embodiments are directed toward a composition that provides nutrients for soil while minimizing the unit cost of the composition. Also provided are methods for increasing nitrogen and mineral content in soil, improving turfgrass quality, increasing soil microbial content, and fertilizing horticultural or agricultural crops using the various compositions.

### BRIEF SUMMARY

The various non-limiting embodiments of the present disclosure contemplate soil conditioners, fertilizer compositions and various methods of increasing the nitrogen content of soil, promoting crop production, and fertilizing horticultural and agricultural crops, including, for example, turf grass.

According to one non-limiting embodiment, the present disclosure includes a fertilizer composition comprising an organic compound, a lysine product, a fermentation cell broth, an ammonium salt of an organic acid, an amidated organic carboxylic acid, a soluble plant protein, and mixtures of any thereof.

Other non-limiting embodiments include a fertilizer composition comprising means for increasing the nitrogen content of a soil and a dispersing agent. Yet other non-limiting embodiments include a method for increasing nitrogen content in soil. The method comprises applying a fertilizer composition, as described herein, to the soil, such that the fertilizer composition promotes plant growth and/or production.

Further non-limiting embodiments include a method of improving turfgrass quality. The method comprises applying a fertilizer composition, as described herein, to turfgrass. In certain aspects of this embodiment the application of the fertilizer composition may be “true foliar” i.e. to the leaves of the grass or “traditional” i.e. to the root of the grass. Further non-limiting embodiments include a method of improving soil microbial content. The method comprises applying a fertilizer composition, as described herein, to soil.

Another non-limiting embodiment describes a soil conditioner composition, comprising a fertilizer composition and an organic material.

Yet another non-limiting embodiment describes a composition comprising: a fertilizer composition, peat moss, composted bark, a wetting agent and composted manure.

In another non-limiting embodiment, a fertilizer composition comprises a soy powder, a dry lysine product, a liquid lysine product, a lysine fermentation by-product, a threonine fermentation by-product, and combinations of any thereof. Upon application of the organic compound to a turf grass prior to winter dormancy, a color of the turf grass is improved as compared to the turf grass without having the organic compound applied. Methods of fertilizing with the fertilizer composition are also disclosed.

Still further non-limiting embodiments include a method of fertilizing horticultural or agricultural crops. The method comprises applying a fertilizer composition, as described herein, to the horticultural or agricultural crop, such that the fertilizer composition promotes growth and/or production of the horticultural or agricultural crop.

Yet another non-limiting embodiment describes a package containing a fertilizer composition. In one aspect of this embodiment the package may be of a water soluble polymer packaging suitable for delivery of the fertilizer composition. One particular aspect of this embodiment may be a water soluble bag this is not substantially dissolved by the fertilizer composition.

### DESCRIPTION OF DRAWINGS

FIG. 1 is a schematic of effect of one embodiment of a composition of the present invention on turfgrass quality ratings for St. Augustine grass.

FIG. 2 is a schematic of effect of one embodiment of a composition of the present invention on turfgrass quality ratings for St. Augustine grass.

FIG. 3 is a schematic of comparison of various embodiments of compositions of the present invention on turfgrass quality ratings.

FIG. 4 is a schematic of effect of one embodiment of a composition of the present invention on turfgrass quality ratings for Bermuda grass Fairways.

FIG. 5 is a schematic of effect of one embodiment of a composition of the present invention on turfgrass quality ratings for Bermuda grass Fairways.

FIG. 6 is a schematic of effect of one embodiment of a composition of the present invention on turfgrass quality ratings for Bermuda grass Fairways.

FIG. 7 is a schematic of comparison of various embodiments of compositions of the present invention on turfgrass quality ratings for Bermuda grass Fairways.

FIG. 8 is a schematic of comparison of various embodiments of compositions of the present invention on turfgrass quality ratings for dwarf Bermuda Greens.

FIG. 9 is a schematic of effect of one embodiment of a composition of the present invention on soil bacterial populations.

FIG. 10 is a schematic of effect of one embodiment of a composition of the present invention on Phyto toxicity ratings in Fairways.

FIG. 11 is a schematic of effect of one embodiment of a composition of the present invention on Phyto toxicity ratings in Fairways Bent grass.

FIG. 12 is a schematic of effect of one embodiment of a composition of the present invention on Phyto toxicity ratings in Greens.

FIG. 13 is a schematic of effect of one embodiment of a composition of the present invention on Phyto toxicity ratings in Greens Bent grass.

FIG. 14 is a schematic of effect of one embodiment of a composition of the present invention on Phyto toxicity ratings in Lawns Bluegrass.

FIG. 15 is a schematic of effect of one embodiment of a composition of the present invention on percent burn in Tall Fescue.

FIG. 16 is a schematic of effect of one embodiment of a composition of the present invention on turfgrass quality ratings for Tall Fescue.

FIG. 17 is a schematic of effect of one embodiment of a composition of the present invention on percent burn in Fairway Bermuda grass.

FIG. 18 is a schematic of effect of one embodiment of a composition of the present invention on turfgrass quality ratings in Fairway Bermuda grass.

FIG. 19 is a schematic of effect of one embodiment of a composition of the present invention on percent burn in Greens.

FIG. 20 is a schematic of effect of one embodiment of a composition of the present invention on turfgrass quality ratings in Greens.

### DETAILED DESCRIPTION

The development of organic fertilizers has continued. U.S. patent application Ser. No. 11/549,470 entitled “Fertilizer and Methods of Using,” assigned to Archer Daniels Midland Company and filed on Oct. 13, 2006, the contents of the entirety of which is incorporated herein by this reference, describes the use of various organic fertilizers. The present invention describes additional organic fertilizers and uses thereof.

Other than in the operating examples, or where otherwise indicated, all numbers recited herein expressing quantities of ingredients, reaction conditions and the like are to be understood as being modified in all instances by the term “about”. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Also, unless denoted otherwise, percentages of components in a composition are presented as weight percent.

The present disclosure describes several different features and aspects of the invention with reference to various exemplary non-limiting embodiments. It is understood, however, that the invention embraces numerous alternative embodiments, which may be accomplished by combining any of the different features, aspects, and embodiments described herein in any combination that one of ordinary skill in the art would find useful.

Application of nutrient soil conditioners to soil in which commercial crops, such as, for example, fruits, vegetables, grains, grasses, for example turf grasses, and other horticultural and agricultural products, are planted is one approach for increasing production and growth of such crops or grasses.

Turfgrass may be defined as a grass cover established on a site for various uses including, but limited to, preventing erosion and maintaining visibility (e.g. a road side); to reduce dust, glare, and surface temperatures (e.g. a lawn or a park); to beautify the surroundings (e.g. a lawn); and to provide a playing surface for sports and recreating (e.g. athletic fields and golf courses).

The grass family (Gramineae) includes over 500 species of plants, but about 40 species are suited for turf use. These include without limitation the genus Bermuda grass (Cynodon spp.) with the species C. dactylon [L.] Pers. being the most widespread. Other grasses common in the United States include, but are not limited to, Saint Augustine grass (Stenotaphrum secundatum), Tall fescue (Festuca spp.), Bent grass (Agrostis), Buffalograss (Buchloe dactyloides), Kentucky bluegrass (Poa pratensis), and Ryegrass (Lolium spp.). Details on various varieties of turfgrasses and their use are described in “Turfgrasses—Their Management and Use in the Southern Zone” by Richard L. Duble (Texas A&M University Press, 2^{nd} Ed. 2001), the contents of the entirety of which are incorporated herein by reference.

Turfgrass growth and maintenance requires optimization of water, nutrients and herbicides. Soil nutrients, such as, nitrogen, phosphorus, potassium, and sulfur, as well as trace elements such as iron, zinc, copper, and magnesium, are useful for achieving thriving agriculture and growth of the plants. However, upon repeated planting cycles, the quantity of these nutrients in the soil may be depleted as plants utilize the nutrients. Depletion of nutrient levels in the soil may result in inhibited plant growth and decreased production per acre. To counter this effect, soil conditioners and fertilizers have been developed to help replace the depleted vital nutrients in soil so that optimal plant growth and high yields may be obtained.

Soil conditioners may be classified as either organic soil conditioners or inorganic soil conditioners. As used herein, the term “organic” includes having a molecular skeleton comprising a carbon backbone. Organic soil conditioners are made from materials derived from living things. Examples of organic fertilizers include, but are not limited to, animal manures, compost, bone meal, feather meal, peat, and blood meal. Inorganic soil conditioners, on the other hand, are manufactured from non-living materials and include, for example, ammonium nitrate, ammonium sulfate, urea, potassium chloride, potash, ammonium phosphate, anhydrous ammonia, and other phosphate salts.

Other compounds that may be used with compositions of the present invention and methods of applying the compounds of the present invention include, but are not limited to, a compound selected from the group consisting of ammonium nitrate, ammonium sulfate, urea, potassium chloride, potash, ammonium phosphate, anhydrous ammonia, a phosphate salt, phosphorus, potassium, sulfur, iron, zinc, copper, magnesium, a fermentation cell broth, an ammonium salt of an organic acid, an amidated organic carboxylic acid, products and/or by-products generated at an agricultural product processing facility, a protein, a surfactant, an emulsifier, an antifoaming agent, a dispersant, a herbicide, an insecticide, a kelp extract, and combinations of any thereof.

Inorganic soil conditioners are readily commercially available and contain nutrients in soluble form that are immediately available to the plant. Inorganic soil conditioners are generally inexpensive, having a low unit cost for the desired element. In addition, the exact amount of a given element may be calculated and administered to the plant or soil.

However, some inorganic soil conditioners may suffer from disadvantages. First, inorganic soil conditioners, especially nitrogen soil conditioners, may be subject to leaching to levels below the root of the plant. This leaching may occur as a result of rain or irrigation, and may result in contamination of ground water, community drinking water, and/or wells by soil conditioner components. Such leaching may render the nutrients unavailable to the plant's roots and result in wasted money being spent on the leached soil conditioners. Second, excess application of the inorganic soil conditioner may result in phytotoxicity, such as, burning of the plant tissue (foliar burn) and roots, particularly with young plants. Finally, inorganic soil conditioners may lead to build up of toxic concentrations of salts in the soil due to heavy or non-systematic application of the soil conditioner. Alternatively, chemical imbalances may develop if soil nutrient content is not closely monitored.

Organic soil conditioners, on the other hand, are typically not as immediately available to plants and may require soil microorganisms to break the organic soil conditioner components down into simpler structures prior to use by the plants. This break-down occurs over a time period and may provide for slower release of nutrients. Organic soil conditioners usually have a low salt index, so larger amounts may be applied at one time without causing injury to the plant. In addition, buildup of toxicity in the soil is unlikely. However, the cost of organic soil conditioners on a unit cost of nutrients basis is typically higher than the inorganic counterparts making the commercial application of conventional organic soil conditioners cost prohibitive.

In addition, organic soil conditioners may not only elicit a plant growth response as observed with common inorganic soil conditioners, but natural organic soil conditioners may also stimulate soil microbial population growth and activities. Increased soil microbial population may have significant beneficial effects on the physical and chemical properties of the soil, as well as increasing disease and pest resistance.

There is, therefore, a need for soil conditioners that do not exhibit the disadvantages of known inorganic soil conditioners, but include many or all of the advantages exhibited by these products.

Fertilizers, according to the various embodiments of the present disclosure, may be applied to soil, agricultural or horticultural crops in an amount that promotes plant growth, promotes growth of beneficial soil microbes, and/or replenishes various nutrients that may have been depleted from the soil such as, for example, as a result of repeated planting cycles or that may have been depleted by leaching. Alternatively, the fertilizers may be applied to soils having low or insufficient nutrient levels and/or soil microbe levels to support efficient agricultural production of crops, such as, for example, land that is currently unsuitable for farming or crop production.

In other non-limiting embodiments, the fertilizers of the present disclosure may promote growth of a plant in a hydroponic or aeroponic system.

According to certain non-limiting embodiments of the present disclosure, the one or more organic compounds may comprise a lysine product, a fermentation cell broth, an ammonium salt of an organic acid, an amidated organic carboxylic acid, products and/or by-products generated at an agricultural product processing facility, and a protein, such as a plant derived protein, a bacterial or microbe derived protein, or an animal derived protein, or mixture of any thereof. According to certain non-limiting embodiments, the protein may be substantially soluble in an aqueous solution. According to other non-limiting embodiments, the protein may be substantially insoluble in an aqueous solution.

According to certain non-limiting embodiments, the fertilizers of the present disclosure may have a solid granular or agglomerated formulation. According to certain non-limiting embodiments, the granular or agglomerated formulation may have a mesh size of at least 5 (i.e., the particles would have a size of about 4 mm or smaller). According to other non-limiting embodiments, the mesh size may be from about 10 mesh to about 5 mesh (i.e., the particle size would range from about 2 mm to about 4 mm). Pellet size may be coarse (over 200 size guide number (SGN)) by certain industry standards, but smaller pellet size may equate to a larger surface area which may allow for more extensive and rapid soil microbial activities and release of nutrients. According to various embodiments where the fertilizer has a solid formulation, the fertilizer may be at least substantially soluble in water at a temperature from 32° F. to 140° F.

In another non-limiting embodiment, the fertilizer may be admixed with a surfactant, an emulsifier, an antifoaming agent, and/or a dispersant for enabling the fertilizer to disperse in a solution. In one non-limiting embodiment, the surfactant may include, but is not limited to, agricultural surfactants, such as, anionic surfactants, cationic surfactants, a non-ionic surfactant, amphoteric surfactants, silicone-based surfactants, alcohol based surfactants, lecithin and combinations of any thereof.

According to other non-limiting embodiments, the fertilizer of the present disclosure may have an aqueous homogeneous solution or an aqueous heterogeneous suspension formulation. For example, when the one or more organic compounds of the fertilizer, as defined herein, comprises a water soluble salt of the one or more organic compounds, such as, for example, lysine monohydrochloride (“lysine (HCl)”), lysine sulfate, or other soluble lysine salt, or an ammonium salt of an organic acid, and the water soluble salt may be substantially dissolved into an aqueous solution prior to dispersion and application to the soil or plant.

In another embodiment, the soluble lysine salt may be in the form of aqueous mother liquor from a lysine crystallization/isolation process, for example a crystallization of lysine (HCl). According to certain embodiments, aqueous mother liquor may comprise an aqueous solution of from about 20% to about 25% by weight of lysine. Alternatively, the one or more organic compound of the fertilizer compositions may comprise lysine free base, which may be substantially soluble in water and form an aqueous homogeneous solution. Alternatively, the organic compound(s), such as, in one non-limiting example, a fermentation cell broth, may comprise an aqueous heterogeneous suspension which may be sprayed or otherwise dispersed onto the soil or plant.

According to certain non-limiting embodiments, the fertilizer of the present disclosure may comprise one or more organic compounds comprising one or more lysine products. As used herein, the term “lysine product” includes a product comprising the amino acid lysine (C₆H₁₄N₂O₂) and salts or derivatives thereof, and the term “lysine” includes all isomers of lysine (i.e., L-lysine, D-lysine, and any mixture of L- and D-lysine). Lysine has a C to N ratio of 3:1. The lysine products according to various non-limiting embodiments may comprise nitrogen content ranging from about 9% N to about 20% N, depending of the formulation. In certain embodiments, the nitrogen content of the lysine products may range from about 9% N to about 15% N.

Various non-limiting examples of lysine products suitable for use in the present disclosure include, but are not limited to, water soluble salts of lysine, such as, for example, lysine monohydrochloride (“lysine (HCl)”), lysine hydrate, lysine dihydrochloride, and lysine sulfate; lysine free-base; aqueous solutions of lysine free-base; granular lysine; lysine cell waste; lysine cell mass; lysine raffinate; a lysine mother liquor, or mixtures of any thereof.

According to certain non-limiting embodiments, the aqueous solution of lysine free-base may comprise LIQUID LYSINE™ brand lysine (a trademark of and product commercially available from Archer Daniels Midland Co. of Decatur, Ill.). According to other non-limiting embodiments, the aqueous solution of lysine free-base may comprise an aqueous solution comprising from about 5% by weight to about 95% by weight of lysine free-base. According to other non-limiting embodiments, the aqueous solution of lysine free-base may comprise an aqueous solution comprising from about 15% by weight to about 85% by weight of lysine free-base. According to still other non-limiting embodiments, the aqueous solution of lysine free-base may comprise an aqueous solution comprising from about 25% by weight to about 75% by weight of lysine free-base. According to other non-limiting embodiments, the aqueous solution of lysine free-base may comprise an aqueous solution comprising from about 35% by weight to about 65% by weight of lysine free-base. According to other non-limiting embodiments, the aqueous solution of lysine free-base may comprise an aqueous solution comprising from about 45% by weight to about 55% by weight of lysine free-base. In other non-limiting embodiments, the lysine content of the aqueous solution of lysine free-base may be increased as desired by either removal or lowering the amount of water in the solution or by the addition of an additional lysine product, such as a soluble salt of lysine, for example, lysine HCl and/or lysine sulfate. Alternatively, according to other non-limiting embodiments, the lysine content of the aqueous solution of lysine free-base may be decreased as desired by the addition of water to the solution.

In one embodiment, the LIQUID LYSINE brand lysine is an approximately 50% (by weight) aqueous solution of L-lysine free-base obtained by concentrating lysine from a lysine fermentation broth. LIQUID LYSINE brand lysine is a dark brown liquid having a crude protein content of about 60% (may range from 50-70%, as measured by a nitrogen content times 6.25); a density of from about 9.5 lbs/gal to about 9.6 lbs/gal; an L-lysine content of about 50% (may range from 45-55%); an isometric purity of about 100%; a pH of between about 9.6-11; a nitrogen content of about 9.58% (may range from 8.5-11%); includes measurable amounts of cysteine (about 0.02%), methionine (about 0.01%), arginine (about 0.08%), tryptophan (less than about 0.04%) and glutamic acid (about 1.0%); includes measurable amounts of calcium (less than about 0.01%), phosphorus (less than about 0.01%), potassium (about 0.10%), sodium (less than about 0.02%), chloride (about 0.10%), and sulfur (about 0.10%). The LIQUID LYSINE brand lysine may be sprayed directly onto the soil in an amount of about 1.0 L/acre to about 350 L/acre or diluted with water to a concentration of about 1% to about 99% by weight of LIQUID LYSINE brand lysine and the diluted solution applied to the soil in an amount of about 1.0 L/acre to about 4000 L/acre.

Lysine monohydrochloride (HCl) is commercially available in the form of L-lysine (HCl) (commercially available from Archer-Daniels-Midland Company, Decatur, Ill.). L-lysine (HCl) may be obtained from, for example, but not limited to, purifying the product of a lysine fermentation process by crystallization of the hydrochloride salt. L-lysine monohydrochloride (available from Archer-Daniels-Midland Company, Decatur, Ill., as well as other suppliers) may be utilized either as a granular solid or as an aqueous solution. L-lysine (HCl) has a purity of at least 98.5% (ranging from 95-99%), a crude protein content of about 94.4% (ranging from 90-98%, as measured by a nitrogen content times 6.25), a chloride content of about 19.7% (ranging from 18-22%), and an L-lysine content of about 78.8% (ranging from about 72-85%) with about 100% isomeric purity. Commercial L-Lysine (HCl) may come in the form of tan colored granules having a particle size of <1.19 mm (85%) and <0.17 mm (5%). L-Lysine (HCl) has a solubility in H₂O at 25° C. ranging from 500 g/L to 600 g/L. and has a bulk density ranging from 0.61 g/cm³ to 0.71 g/cm³. The L-lysine (HCl) may be feed grade, commercial grade, or any other suitable grade. L-lysine (HCl) has a nitrogen content of approximately 15% and is readily available at a low unit cost of nitrogen. The L-lysine (HCl) may be applied to soil in an amount of about 50 lbs/acre to about 1500 lbs/acre.

It is also contemplated that other amino acids may be suitable for use as or to be used in combination with the one or more organic compounds in the present disclosure. For example, the non-limiting embodiments of the present disclosure may include a fertilizer composition comprising an amino acid product selected from the group consisting of an arginine product, a methionine product, a threonine product, and combinations of any thereof. The amino acid products may include water soluble salts of the amino acid, free-bases of the amino acids, aqueous solutions of the amino acid salt and/or free-base, and combinations of any thereof. Fertilizer compositions comprising other naturally occurring amino acids are also contemplated.

In another embodiment, a stream of an agricultural process may be used by itself or in conjunction with an amino acid product to produce a fertilizer composition. In one example, an aqueous stream may be subjected to a pH adjustment to precipitate various constituents of the aqueous stream, and the precipitated products may be separated from the remaining aqueous portions. The remaining aqueous portions may be dried and used as the fertilizer composition or combined with the amino acid product.

In one embodiment, a stream of a corn wet mill may have the pH raised by adding NH₃ such that phytic acid and phosphorus are precipitated. The remaining aqueous solution may be dried and used as a fertilizer composition or mixed with the amino acid product to be used as the fertilizer composition. In one example, the dried stream may have the following profile, on a dry weight basis: about 50.39% protein (ranging from 40-60%); about 3.61% fatty acids (ranging from 2.5-5.0%); about 33.11% ash (ranging from 25-40%); about 0.18% calcium (ranging from 0.1-0.25%); about 8.97% phosphorus (ranging from 8-10%); about 4.65% magnesium (ranging from 3.5-5.5%); about 2.89% potassium (ranging from 2-4%); less than about 0.01% sodium; about 581.40 PPM iron (ranging from 450-700 PPM); about 880.40 PPM zinc (ranging from 750-1000 PPM); about 37.0 PPM copper (ranging from about 30-45 PPM); about 210.40 PPM manganese (ranging from about 150-260 PPM); and about 0.742% sulfur (ranging from about 0.5-1.0%).

According to certain non-limiting embodiments, the fertilizer composition of the present disclosure may comprise one or more organic compounds comprising a lysine product selected from the group consisting of a water soluble salt of lysine including, but not limited to, a mono-potassium phosphate salt of lysine; lysine (HCl); lysine free-base; liquid lysine; lysine dihydrochloride; and lysine sulfate and mixtures of any lysine product. Lysine (HCl) has a nitrogen content of about 15% by weight. Lysine sulfate has a nitrogen content of about 10% by weight. Lysine free base has a nitrogen content of about 19-20% by weight on a pure basis, which corresponds to about 9.5-10% nitrogen for the 50% aqueous solution in LIQUID LYSINE brand lysine. Aqueous solutions of lysine free-base having a nitrogen content from about 1% to 19% by weight (i.e., from 5% to 95% by weight of lysine free-base) may be prepared as described herein and utilized in certain non-limiting embodiments of the compositions disclosed herein. Lysine free-base and lysine salts, such as lysine (HCl), lysine sulfate, potassium phosphate salts of lysine and the like, are generally soluble in aqueous solutions and may be applied to soil or plants by dissolving the lysine salt in an aqueous solution followed by application of a sufficient volume of the solution to the soil and/or plant to yield the desired amount of nitrogen. Solutions of lysine product may be applied directly to the plant, for example, as a foliar spray or may be applied to the soil by spraying the solution onto the soil in a desired amount.

In another embodiment, the lysine salts, as described herein, may be applied to the soil and/or plant in a solid, granular, or powdered form, such application may be followed by watering (i.e., by irrigation, rain fall, etc.) to disperse the lysine product into the soil for microbial breakdown. According to other non-limiting embodiments, the fertilizers disclosed herein may be applied to a plant, such as turf grass, or soil containing such a plant in an amount measured by the weight of nitrogen (as calculated by the N component from the N-P-K value) per unit area per unit time. For example, according to one non-limiting embodiment, the fertilizers may be applied in an amount from 0.0625 lb nitrogen/1000 ft²/2 weeks to 0.375 lb nitrogen/1000 ft²/2 weeks. According to another non-limiting embodiment, the fertilizer may be applied in an amount from 0.25 lb nitrogen/1000 ft²/month to 3.0 lb nitrogen/1000 ft²/month. According to still other non-limiting embodiments, the fertilizers may be applied in an amount from 0.5 lb nitrogen/1000 ft²/month to 8.0 lb nitrogen/1000 ft²/month.

According to certain non-limiting embodiments, the fertilizer of the present disclosure may comprise one or more organic compounds comprising a fermentation cell broth, products from a fermentation process, and/or by-products from a downstream recovery process of a fermentation process. As used herein, the term “fermentation cell broth” includes products generated from a fermentation process, such as, but not limited to, an alcohol, such as, for example, ethanol; an organic acid, such as, for example, lactic acid; an ester of an organic acid, such as, for example, lactate esters; an amino acid, such as lysine or threonine; a fungal, or a bacterial fermentation. The broth may comprise the mycelium, the cell mass, or the biomass of yeast or fungal fermentation and the media on or in which it was grown and may comprise the enzyme system of the viable organism and its concomitant metabolites and other products produced during the fermentation process and not removed during one or more separation processes. The broth may further or alternatively comprise a bacterial fermentation mass, such as, for example, a cell mass or a biomass, and the media on or in which it was grown and may comprise the enzyme system of the viable organism and its concomitant metabolites produced during the fermentation process and not removed during the one or more separation processes.

According to one non-limiting embodiment, the fermentation cell broth may be an alcohol fermentation broth, such as an ethanol fermentation broth utilizing yeast as the fermentation medium. Suitable alcohol fermentation yeast varieties include brewer's yeast, baker's yeast and other strains of Saccharomyces, such as, Saccharomyces cerevisiae.

According to other non-limiting embodiments, the present disclosure provides for methods of fertilizing horticultural or agricultural crops, where the methods comprise applying the fertilizer composition, as described herein, to the horticultural or agricultural crop, or the soil in which the horticultural or agricultural crop is planted in, such that the fertilizer composition promotes growth and/or production of the horticultural or agricultural crop and/or increases a soil microbial population.

In yet an additional non-limiting embodiment, the fertilizer may be produced at a first geographic location and transported or shipped to a second geographic location. For instance, a facility at the first geographic location may be able to produce a product more economically than a facility at the second location due to various factors. The factors may include, for example, lower costs of materials, lower costs of energy (e.g., electricity and/or natural gas or other petroleum products), lower costs of labor (e.g., wages paid to employees), lower costs of environmental controls or effects, or any other requirement for production of the organic fertilizer. Thus, the costs of producing the products in the first geographic location may be less than the costs of producing the products in the second geographic location, resulting in the production costs being less in the first geographic location.

In such an instance, the fertilizer may be produced at the first geographic location and shipped to the second geographic location such as by transport over water with ships or barges, trucking, flying, by rail, or other means of transportation. The geographic location may be a county, a state, a country, a continent, and/or combinations of any thereof. In this manner the product may be produced, for example, in a first county, state, country, or continent, and transported to and/or sold in a second county, state, country, or continent.

In another non limiting embodiment, foliar applications of the fertilizers may be used. Foliar applications may include applying the fertilizer as a liquid-spray application to the foliage of the plant. In this manner, foliar composition is applied at low rates in low volumes of water to the foliage of the plant. This allows mineral nutrients for most part, to remain in a water film on the foliage and get adsorbed by the leaf tissue. In one aspect of this embodiment, the foliar composition may be applied at a water usage rate of 0.5 gallons of water per 1000 ft² to 10 gallons of per 1000 ft². In yet another aspect of this embodiment, a water usage rate of 0.5 gallons of water per 1000 ft² to 2 gallons of water per 1000 ft² may be used.

Other embodiments describe a method of packaging the fertilizer composition in a water soluble polymer packaging. Such packaging may be of a water-soluble polymer film wherein the fertilizer composition is contained within a package constructed of the water-soluble polymer file, dispersed within the thickness of the film, or wherein the resultant film is either formed into a container to hold the fertilizer composition or laminated to another film within which is dispersed another fertilizer composition.

In another embodiment, a container system may be used comprising at least one inner water soluble (or water dispersible) bag located within an outer water soluble (or water dispersible) bag. Each water soluble bag independently contains a fertilizer composition that does not substantially dissolve the bag, or bags, which it contacts. In such cases two fertilizer compositions may be stored in the inner and outer bag, respectively, which need not be mixed until the time of application. For instance, in one embodiment, liquid lysine may be stored in an outer bag while granular lysine hydrochloride powder may be stored in the inner bag. Each bag remaining without contact with one another until the time of application when the bags are dissolved in water. Such a bag system enables the ease of application of the compositions described herein to managers of sports fields, lawns, parks, playgrounds, golf greens, bowling greens, tennis courts, roadsides, cemeteries and other general purpose turf locations. Suitable components used for the manufacture of such bags or containers may comprise polyethylene oxide, such as polyethylene glycol; starch and modified starch; alkyl and hydroxyalkylcellulose, such as hydroxymethylcellulose, hydroxyethylcellulose, hydroxypropyl cellulose; carboxymethylcellulose; polyvinylethers such as poly methyl vinylether or poly(2-methoxyethoxyethylene); poly(2,4-dimethyl-6-triazinylethylene; poly(3-morpholinyl ethylene); poly(N-1,2,4-triazolylethylene); poly(vinylsulfonic acid); polyanhydrides; low molecular weight melamine-formaldehyde resins; low molecular weight urea-formaldehyde resins; poly(2-hydroxyethyl methacrylate); polyacrylic acid and its homologs, and combinations of any thereof. The water-soluble polymer films used in the present invention may be of any suitable film-forming material such as polyvinyl alcohol, methyl cellulose, poly (hydroxyalkanoate), poly(Lactate); polymethylene oxide, sodium carboxy methyl cellulose, polyvinyl pyrrolidone or polyacrylamide selected in the film thickness used and particular form of packaging to for polymer film that is both sufficiently tough and flexible to withstand fabrication, filling, and handling. Bags and packages of such type are described in U.S. Pat. Nos. 5,558,228 and 5,323,906, which are incorporated herein by reference in their entirety.

Various embodiments of fertilizer compositions according to the present disclosure will be exemplified in the following examples. Those having ordinary skill in the relevant art will appreciate that various changes in the components, compositions, details, materials, and process parameters of the examples that are hereafter described and illustrated in order to explain the nature of the invention may be made by those skilled in the art, and all such modifications will remain within the principle and scope of the invention as expressed herein and in the appended claims. It will also be appreciated by those of ordinary skill in the art that changes could be made to the embodiments described above and below without departing from the broad inventive concept thereof. It is understood therefore, that this invention is not limited to the particular embodiments disclosed, but is intended to cover modifications that are within the principle and scope of the invention, as defined by the claims.

### EXAMPLES

Fertilizer used in the examples were Lysine HCl (available from Archer Daniels Midland Company Decatur, Ill.), Liquid Lysine (available from Archer Daniels Midland Decatur, Ill.), Milogranite (available from Milogranite 260 W. Seeboth St. Milwaukee, Wis. 53204), A “blended fertilizer” comprising 50 percent urea and 50 percent methylene urea, Threonine (available from Archer Daniels Midland Company Decatur Ill.), fermentation biomass solids (available from Archer Daniels Midland Decatur, Ill.), Coron (available from Helena Chemical Company, Collierville, Tenn. 38017). In various embodiments disclosed herein 1× rate refers to the application of 1 pound of Nitrogen applied per 1,000 ft2 of applied area and 0.5× refers to the application of ½ pound of Nitrogen per 1,000 ft2 of applied area for all trial materials on lawn, grass or fairway height at each application. Similar 3× rate refers to the application of 3 pounds of Nitrogen per 1000 ft2 of applied area for all trial material on lawn, grass or fairway height at each application.

### Example 1

St. Augustine grass was fertilized monthly at rates of between 0.5 and 3.0 lbs nitrogen/1000 square feet with lysine HCL and Liquid Lysine, which were compared with inorganic, quick release/response urea and the organic industry standard Milorganite. Urea, lysine HCl, and liquid lysine were spray/liquid applied, while Milorganite was applied as a solid granular product.

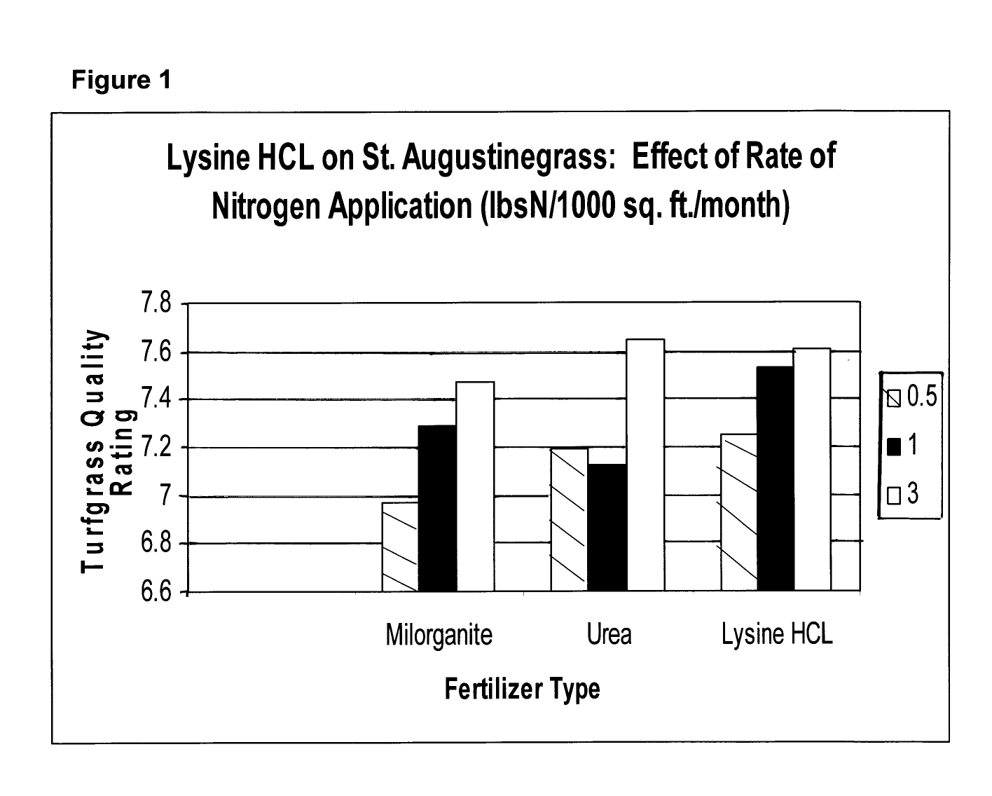

Overall turf quality was rated weekly using a visual scale of 1-9 with 9 representing perfect turf. Ratings higher than 6.0 are considered acceptable, while any rating below 6.0 is unacceptable. Results presented in FIG. 1 indicate that lysine HCL trended better than urea and milorganite throughout the growing season, had acceptable overall turfgrass quality and residual activity even at the half-rate of 0.5 lb nitrogen. At all rates, lysine HCL had seasonally higher overall turfgrass quality ratings, but was noticeably higher at the standard 1.0 lb nitrogen rate as compared to urea and milorganite.

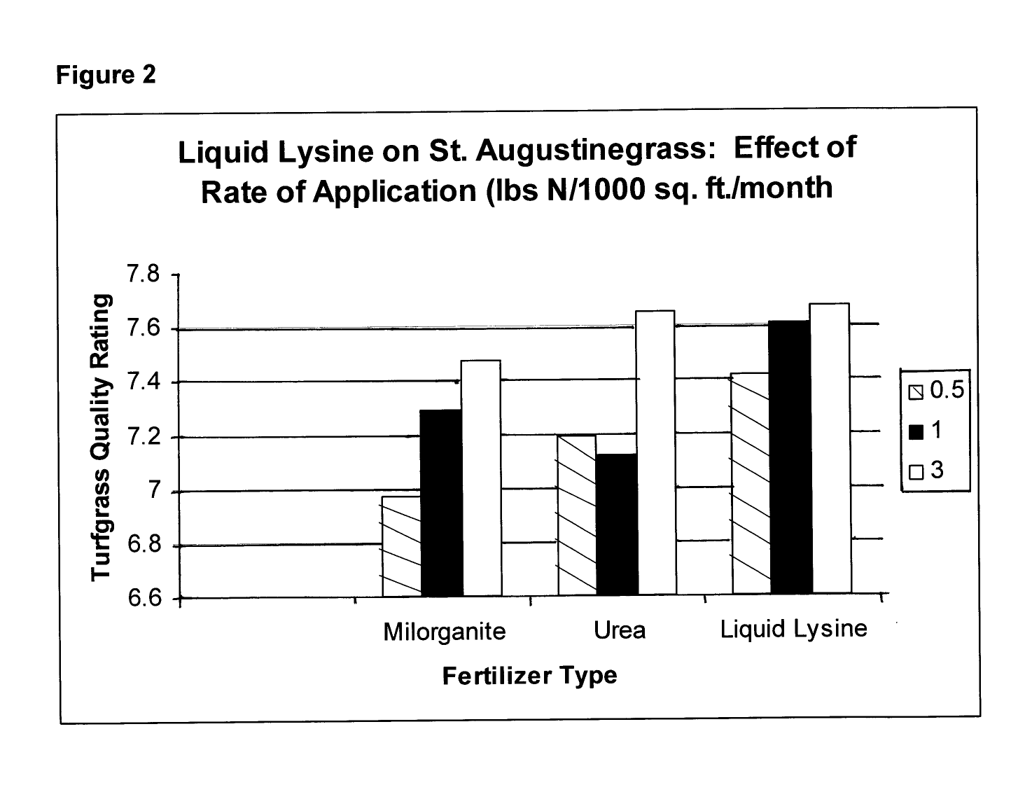

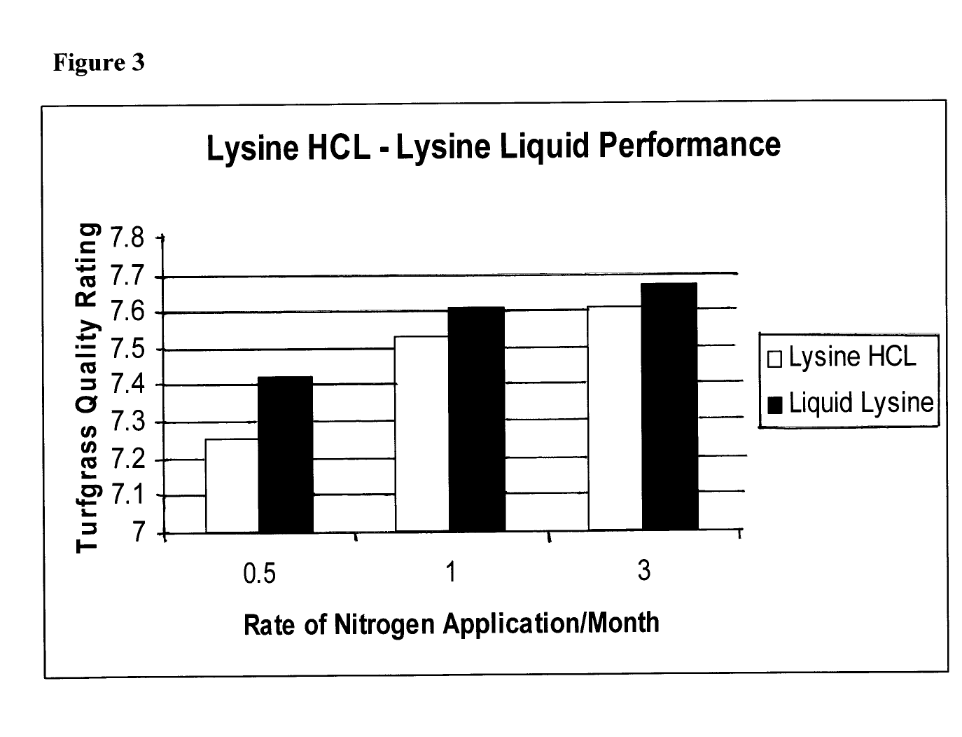

Liquid lysine results are presented in FIG. 2. The lysine liquid trended better in turfgrass quality and residual activity all season long compared to urea and milorganite and had very similar results as compared to the lysine HCL. A comparison of liquid lysine with lysine HCl is presented in FIG. 3. Although not statistically different, the lysine liquid applications were slightly better than the lysine HCL at all nitrogen rates on a seasonal basis.

### Example 2

Bermudagrass was grown and maintained in golf course fairway conditions. The bermudagrass was mown at a ½ inch height of cut and fertilized monthly between 0.5 and 3.0 lbs nitrogen per 1000 square feet. Lysine HCL and liquid lysine in aqueous solutions were compared with inorganic, quick release/response urea and the organic industry standard Milorganite. Urea, lysine HCl and liquid lysine were spray/liquid applied, while Milorganite was applied as a solid granular product.

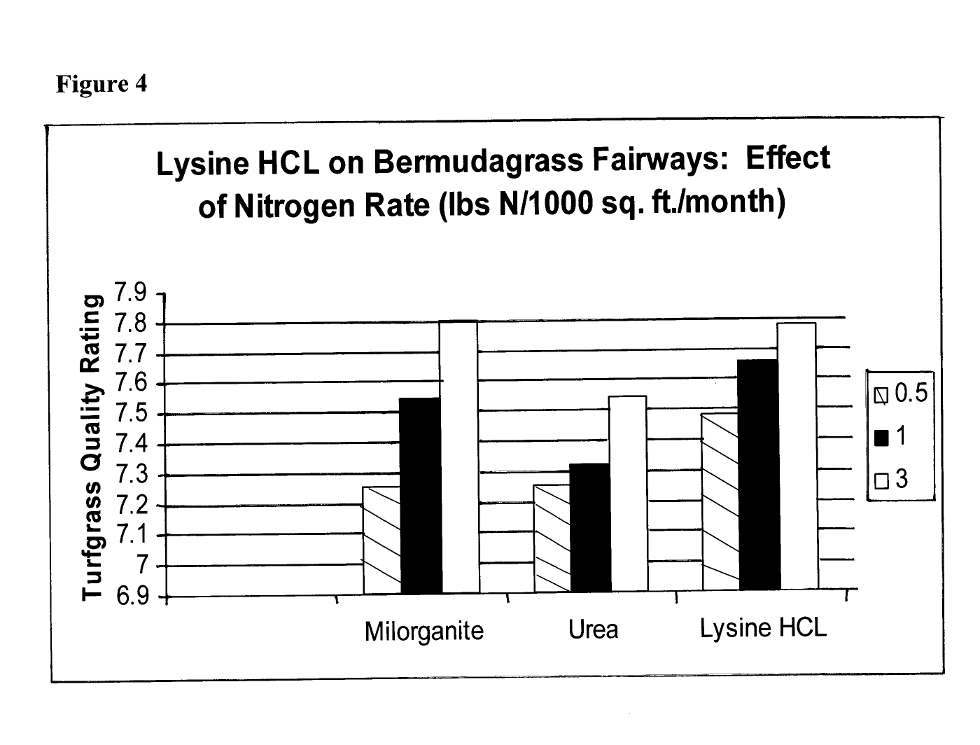

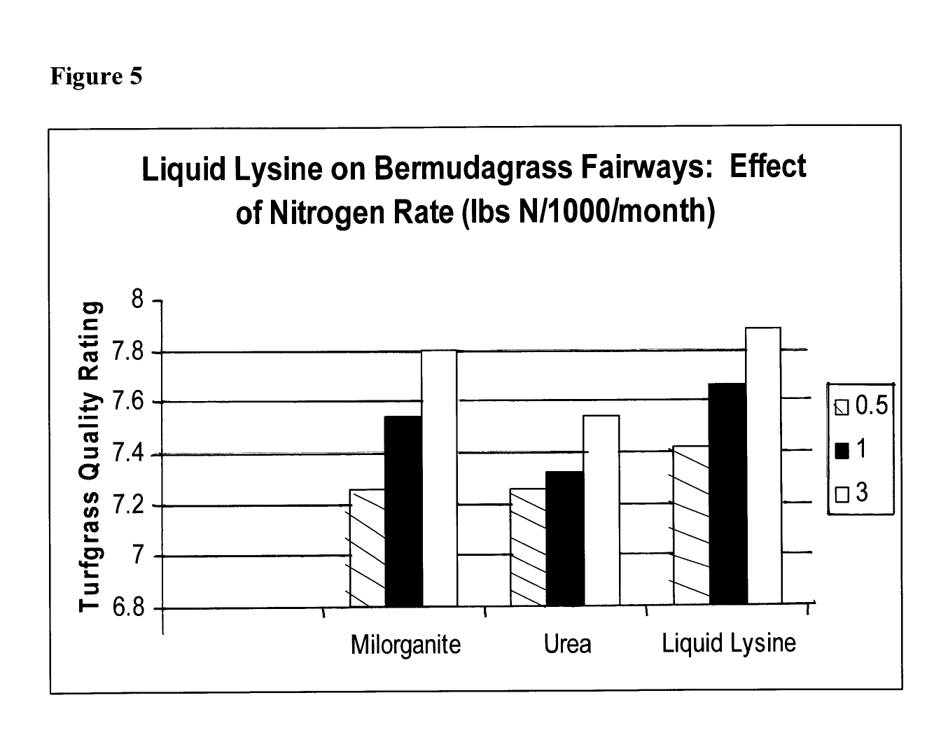

Overall turf quality was rated weekly using a visual scale of 1-9 with 9 representing perfect turf (rarely attained, if ever). Ratings higher than 6.0 are considered acceptable while any rating below 6.0 is considered unacceptable. Total seasonal turfgrass quality averages on testing with lysine HCl and liquid lysine are provided in FIGS. 4 and 5, respectively. Lysine HCL had seasonally better turfgrass quality at all rates tested compared to urea and milorganite. All fertilizers responded with acceptable turf ratings at all application rates, but lysine HCL trended better. These results show that lysine HCL has at least as much or more of a rapid response as compared to urea, along with prolonged residual times typical of milorganite. Liquid lysine was shown to perform substantially the same as lysine HCL and outperformed urea and milorganite at all nitrogen application rates throughout the season.

### Example 3

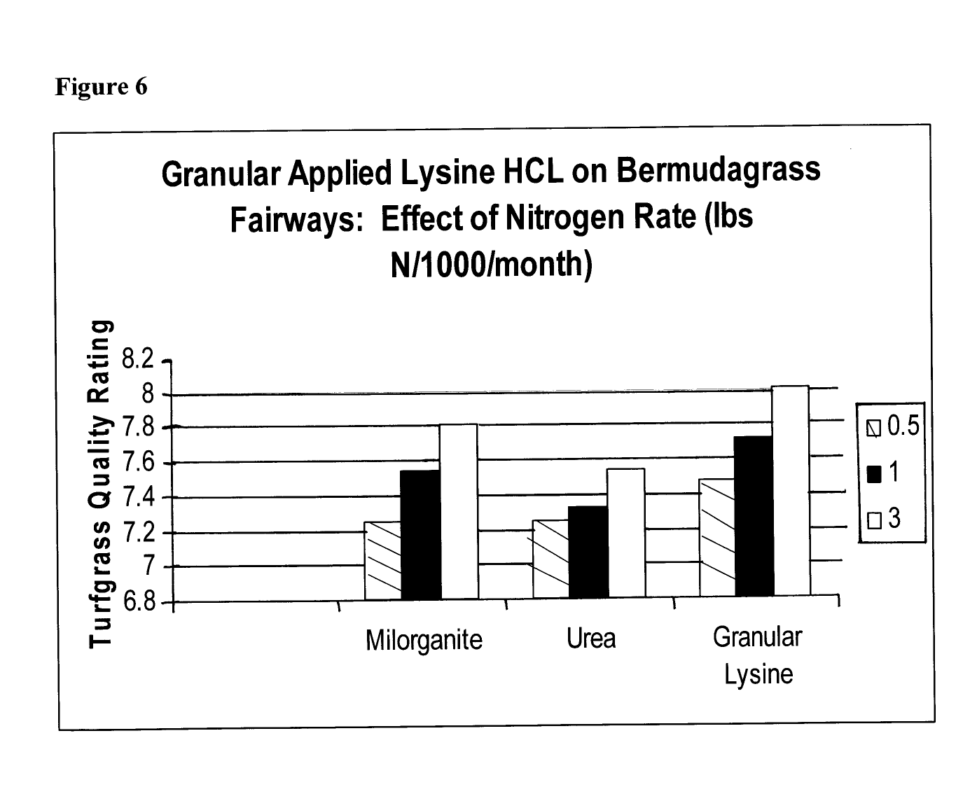

Bermudagrass was grown and maintained in golf course fairway conditions. The bermudagrass was mown at a ½ inch height of cut and fertilized monthly between 0.5 and 3.0 lbs nitrogen per 1000 square feet. Lysine HCl applied as a solid granular was compared with inorganic, quick release/response urea and the organic industry standard Milorganite. Urea was spray/liquid applied, while Milorganite was applied as a solid granular product. Results are presented in FIG. 6.

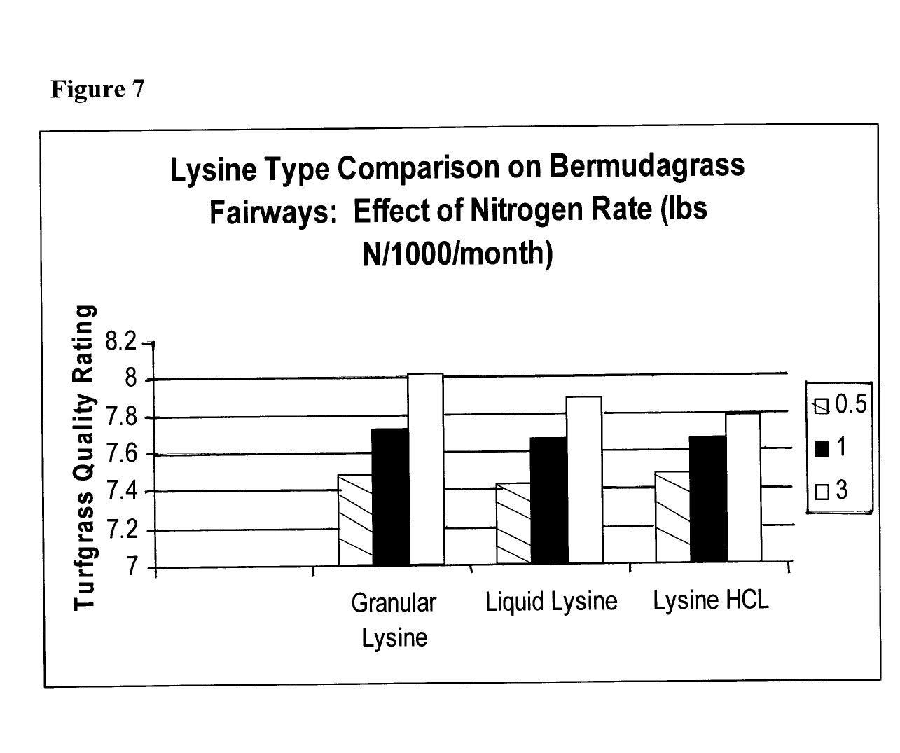

Lysine HCL was applied as a solid granular to compare with spray applied lysine HCL and liquid lysine. The results are presented in FIG. 7.

Overall turf quality was rated weekly using a visual scale of 1-9 with 9 representing perfect turf. Ratings higher than 6.0 are considered acceptable while any rating below 6.0 is considered unacceptable. Granular applications of lysine HCL are as effective as or more effective than Milorganite and urea. These results are significant since many facilities utilize granular applications more often than spray applications. More importantly, the average homeowner applies fertilizers as a granular with a spreader and can expect the same results as with a spray application.

A comparison of the various forms of the lysine products indicates that lysine, as a source of nitrogen, is more effectively utilized when soil applied (as a granular application) rather than as a foliar application (spray application), and that root absorption is somewhat more efficient than foliar absorption. There may also be a more beneficial effect on the soil microbial population since virtually all of the lysine moves into the soil during irrigation events.

### Example 4

Ultra-Dwarf Bermudagrass is a variety bred specifically for golf greens by exhibiting a significantly slower growth rate than other Bermudagrass varieties. Ultra-dwarf bermudagrass is typically mown at ⅛ inch or lower and fertilized on a weekly basis which is termed “spoon feeding”. Lysine HCl, liquid lysine, Milogranite and urea were applied under substantially the same conditions as described in Example 1. Overall turf quality was rated weekly using a visual scale of 1-9 with 9 representing perfect turf. Ratings higher than 6.0 are considered acceptable while any rating below 6.0 is unacceptable.

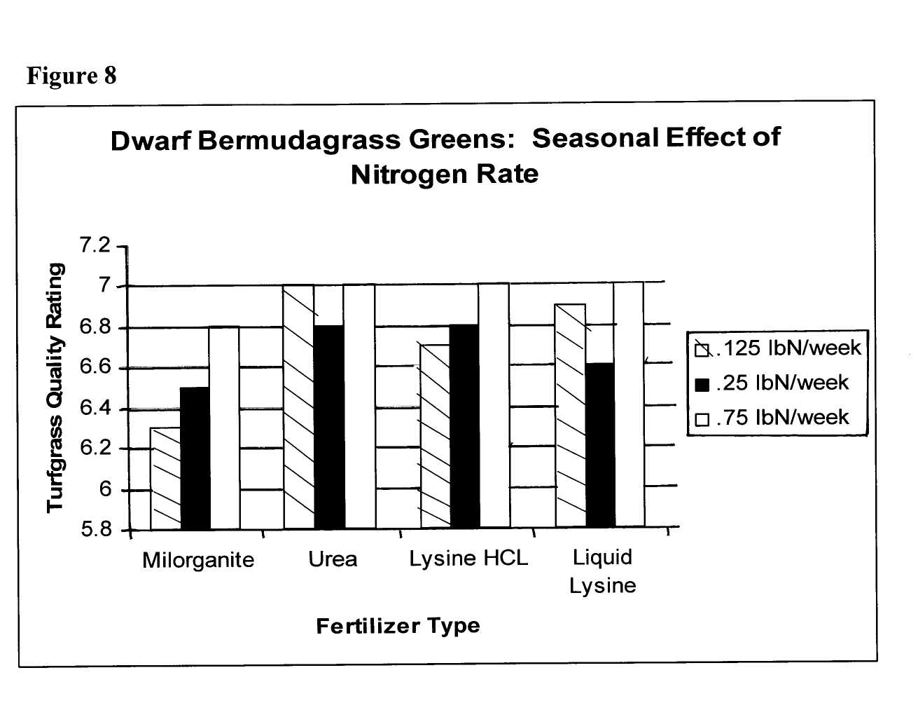

Results are presented in FIG. 8. Performance of liquid lysine and lysine HCl at the normal 0.125 lb nitrogen/week rate were statistically the same as that of urea. Milorganite did not perform nearly as effectively as the other fertilizer sources. These results are a reflection of dwarf nature of this bermudagrass variety as well as the very low mowing heights which result in short root systems and limited leaf area. Use of liquids under these conditions was proven to be much more effective than organic granular products that take a long time to break-down and which may get mown up or stuck on mower rollers.

### Example 5

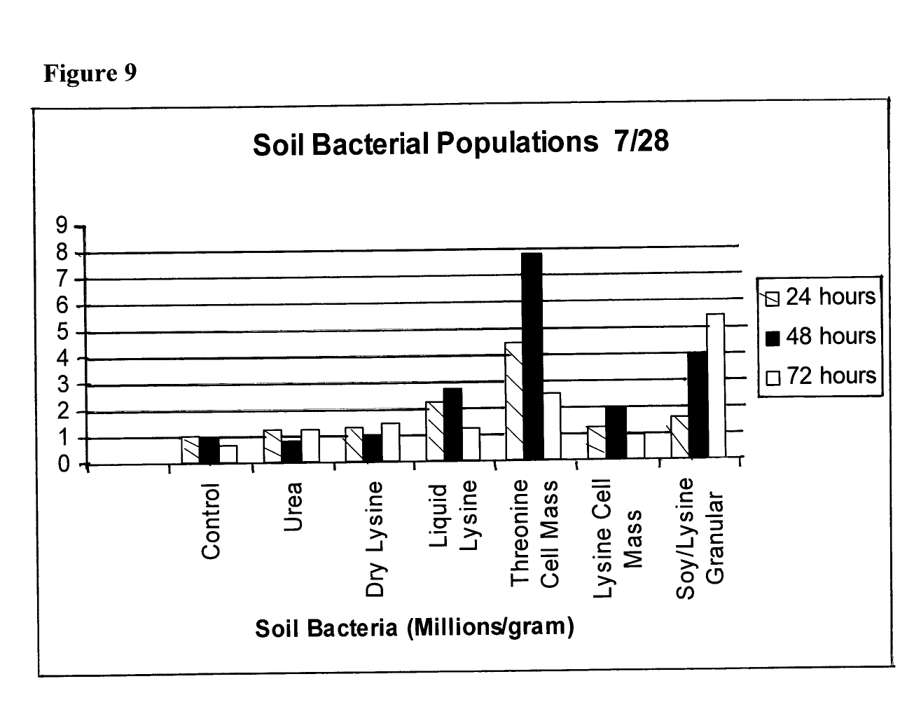

The effect of lysine HCl and liquid lysine on soil microbial populations was studied. Nitrogen “dosing” was the equivalent to the standard nitrogen application rate of 1.0 lb of nitrogen/1000 sq. ft. after which samples were taken 24, 48 and 72 hours after application for analysis. Results are presented in FIG. 9 and soil microbial populations were shown to be enhanced about twice as much for liquid lysine compared to lysine HCl. These represent a 100 percent increase over 48 hours. A more complex material such as the soy-lysine granular mixtures was found to have longer residual activity and higher increases in soil microbial populations.

### Example 6

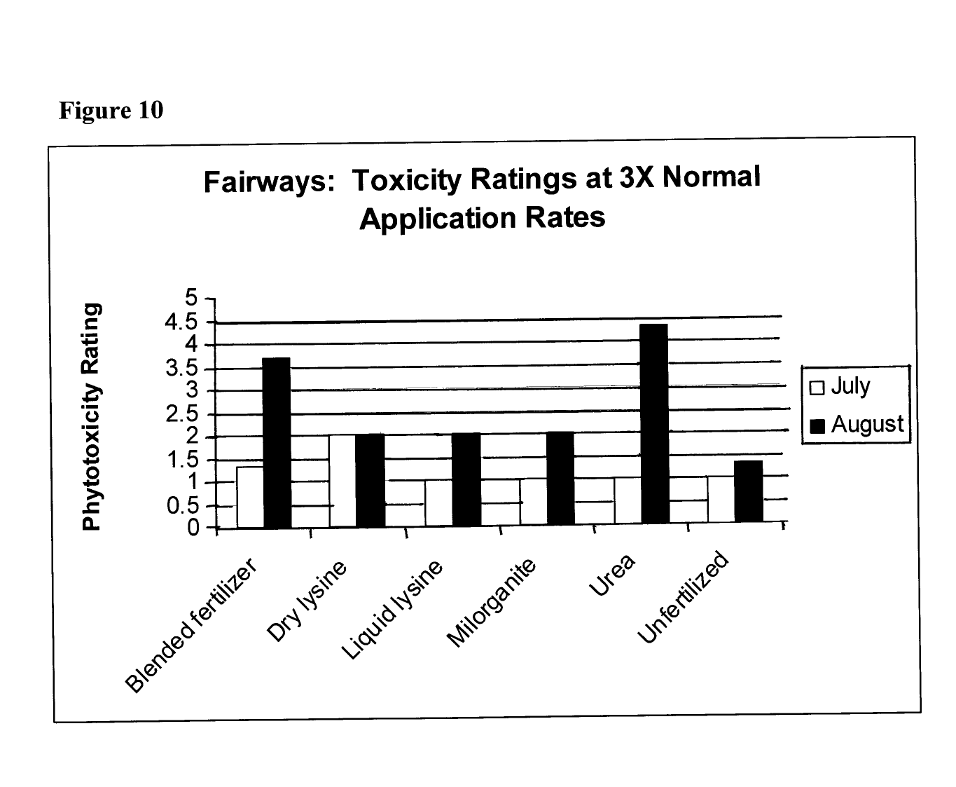

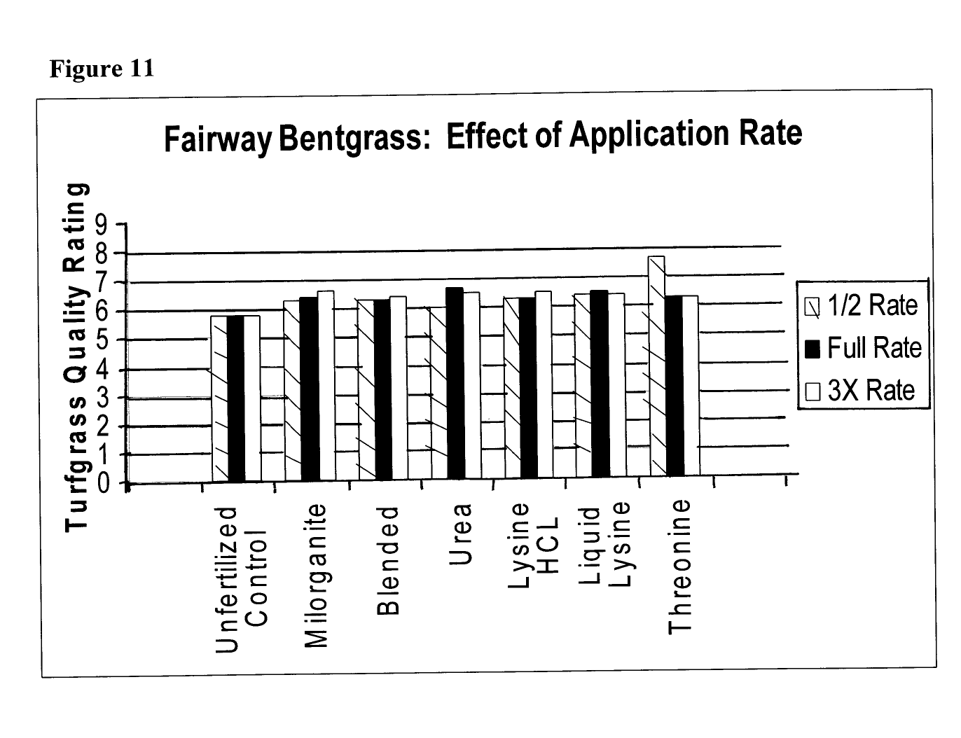

Creeping bentgrass is a major choice for fairways, golf greens and tees in the cool-temperate zone. It has the ability to withstand close mowing and is very “aggressive” which allows for quick recovery from injuries. Creeping bentgrass was fertilized in Fairways substantially the same as described in example 1 at three different rates: half, full and 3× normal rates (0.5, 1.0 and 3.0 lbs nitrogen/1000/month) applied on a monthly basis. Turfgrass quality ratings were taken every month from June through November along with “color” and “phytotoxicity” ratings. Turfgrass quality and toxicity were measured on a 1-9 visual basis with 9 representing the highest quality turf or most injury/burn to the turfgrass. Fairways toxicity ratings and turfgrass quality ratings are shown in FIGS. 10 and 11, respectively. The most crucial months with regard to fertilizer application toxicity are the mid-summer months of July and August due to hotter and more humid conditions which typically amplify any potential for fertilizer “burn” injury.

As presented in FIG. 10, dry lysine HCl and the blended fertilizer (a mixture of 50 percent methylene urea and 50 percent urea) show an insignificant level of injury during July, while the blended fertilizer and urea show significantly more injury than liquid lysine and lysine HCl during the month of August. The turf grass quality ratings shown in FIG. 11 suggest that the lysine products are as effective or slightly more effective than inorganic urea and equally as effective as the blended synthetic organic and standard natural organic Milogranite. The ease of application of liquid lysine and lysine HCl by spraying is an important benefit over the blended fertilizer and natural organic Milogranite.

### Example 7

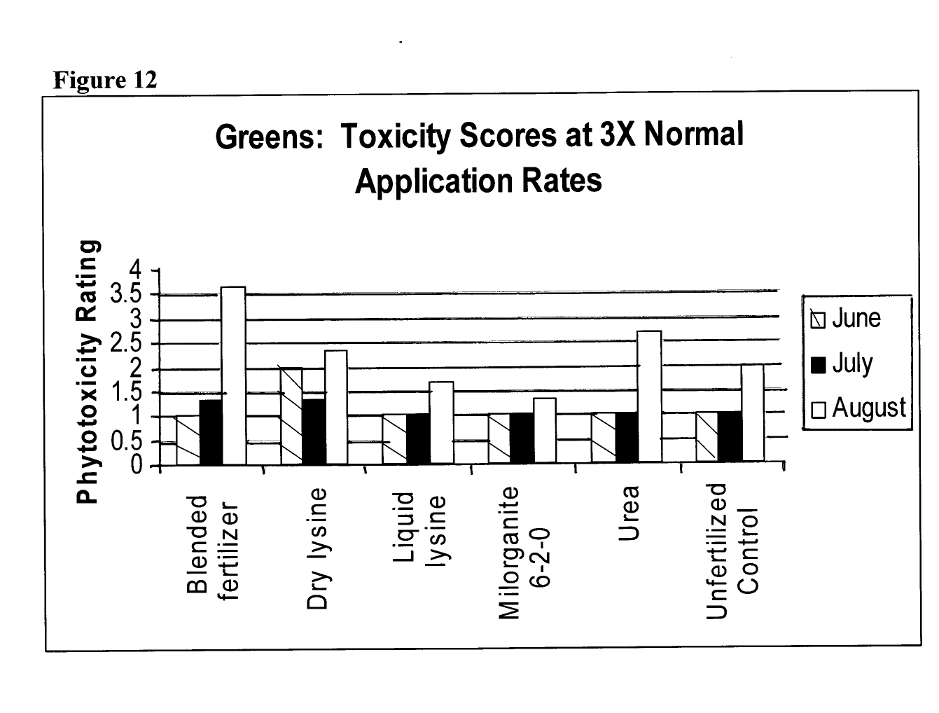

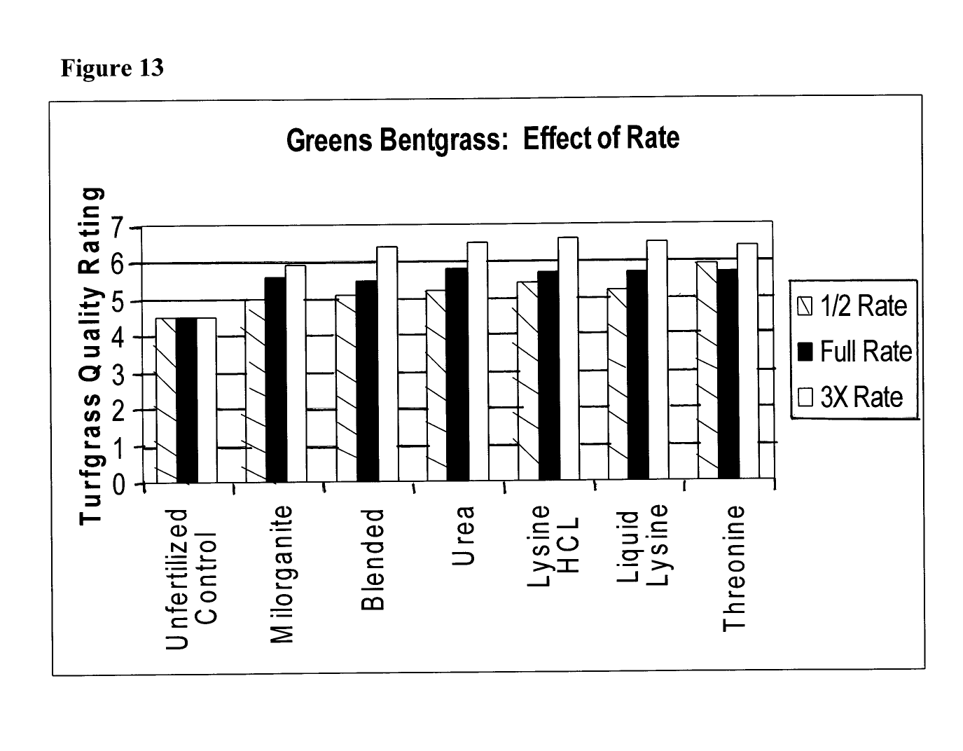

Creeping bentgrass is a major choice for fairways, golf greens and tees in the cool-temperate zone. It has the ability to withstand close mowing and is very “aggressive” allowing for quick recovery from injuries. It was fertilized in greens at half, full and 3× rate of application (0.063, 0.125 and 0.25 lbs nitrogen/1000 sq ft) on a bi-weekly basis. Turfgrass quality and toxicity were measured on a 1-9 visual basis, with 9 representing the highest quality turf or the most injury respectively. Fairways toxicity ratings and turfgrass quality ratings are shown in FIGS. 12 and 13, respectively.

As the most crucial months with regard to fertilizer application toxicity are mid-summer months of July and August due to hotter and more humid conditions, these months typically amplify any potential for fertilizer “burn” injury. Slight and insignificant levels of toxicity were observed during the months of June and July with the blended and lysine HCl applications. With controls subtracted, virtually no toxicity was derived from the fertilizer sources. During the hotter month of August, urea and the blended fertilizer resulted in significantly higher toxicity levels as compared to the lysine products and Milogranite (FIG. 12).

No significant difference was seen in turfgrass quality ratings between any materials at any application rate (FIG. 13). However, an increase in quality was observed with increasing rates of application for all materials. Lysine HCl and liquid lysine were shown to perform slightly better than the blended synthetic products and Milogranite.

### Example 8

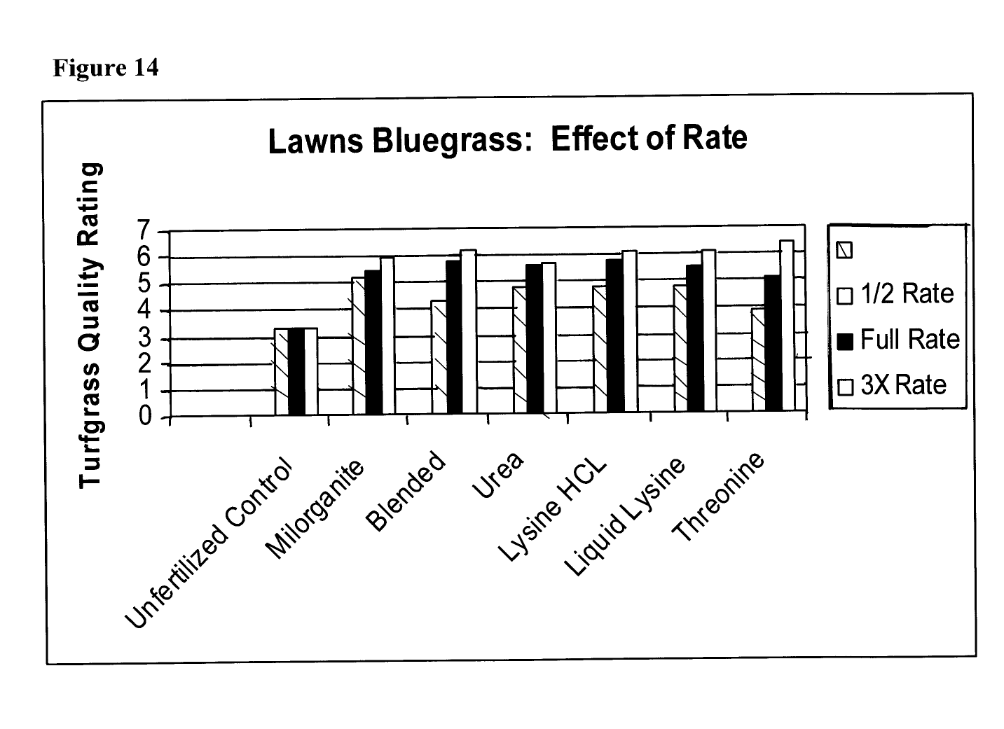

Kentucky blue grass is often used as a turfgrass species in the cool, temperature zone as a blend of varieties or within specialized “mixes” created for various geographical locations. In this embodiment, Kentucky blue grass was fertilized under a normal application rate of 1.0 lb nitrogen per 1000 sq ft per month in high quality, high maintenance lawns. Turfgrass quality and toxicity were measured on a 1-9 visual basis with 9 representing the highest quality turf or the most injury, respectively. No significant phytotoxicity was observed at any rate at any time (data not presented). Data for turfgrass quality is presented in FIG. 14. No material performance difference was seen with the liquid lysine or the lysine HCl, both of which performed marginally better than urea.

### Example 9

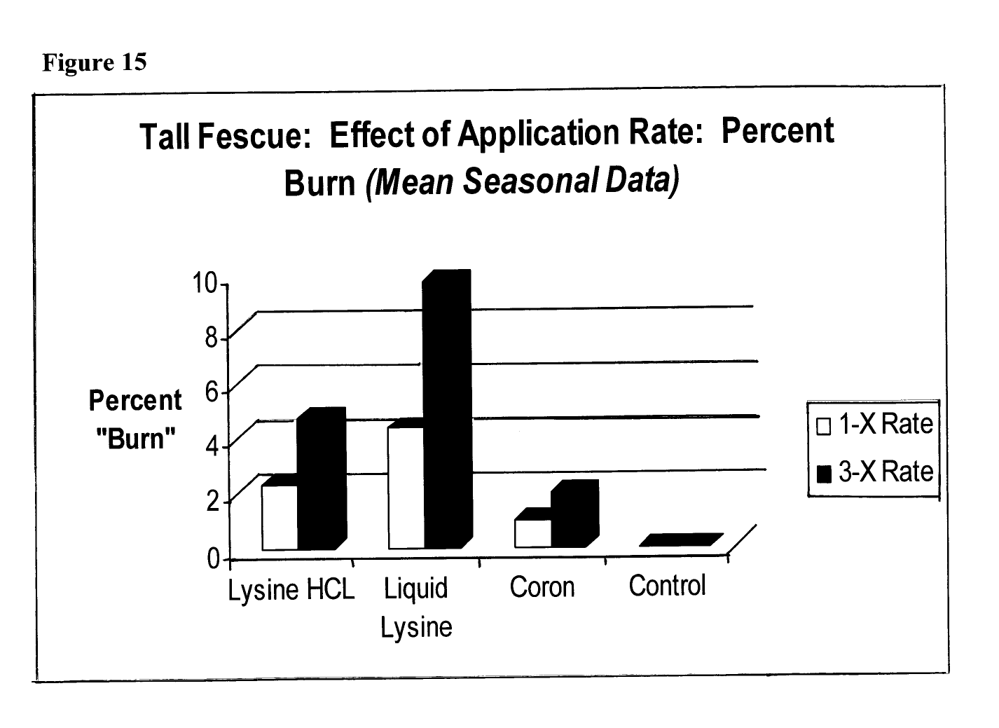

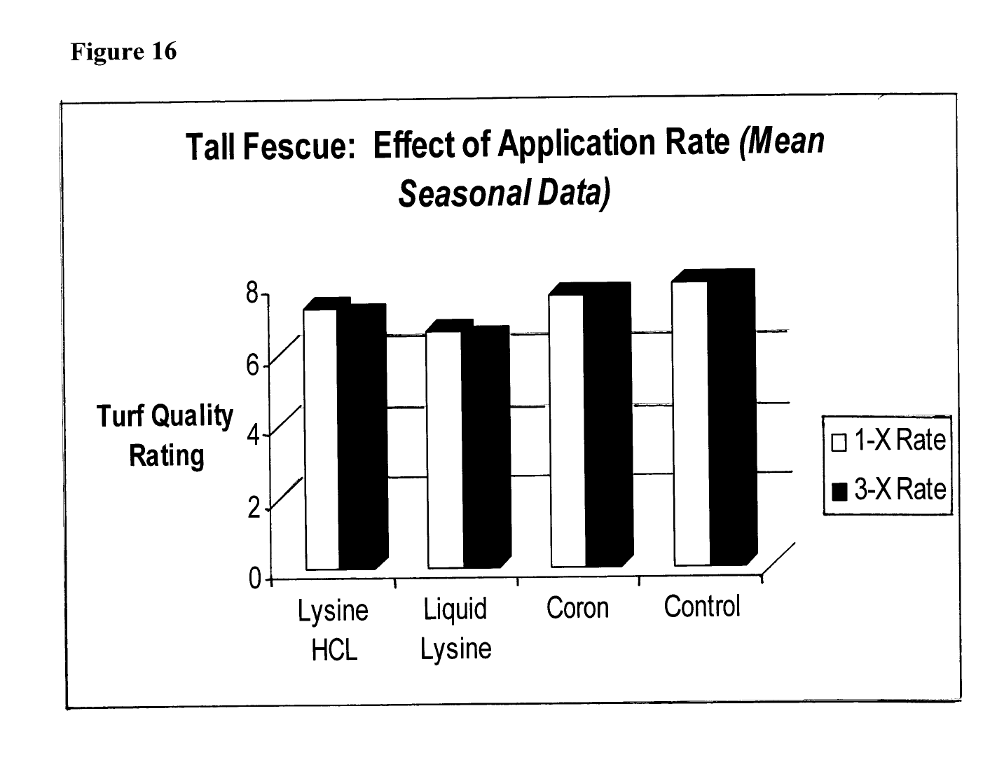

True foliar applications were studied with Tall Fescue grass. Normal foliar rates of 0.5, 1.0 and 3.0 lb nitrogen per 1000 sq ft were used with water volumes in the range of 0.5 to 2.0 gallons per 1000 sq ft (for comparison non-foliar, normal liquid spray applications are typically more than 4.0 gallons of water per 1000 sq ft.) Results are presented in FIG. 15 for mean data taken during a 5 week period. Liquid lysine was found to have more burn potential than lysine HCl. However, as true application rates are ⅛ the 1× rate, burn potential for foliar applications is limited. Turfgrass quality averaged over a 5 week period is presented in FIG. 16. Liquid lysine was found to have a higher rate of burn the 1× and 3× application rates.

### Example 10

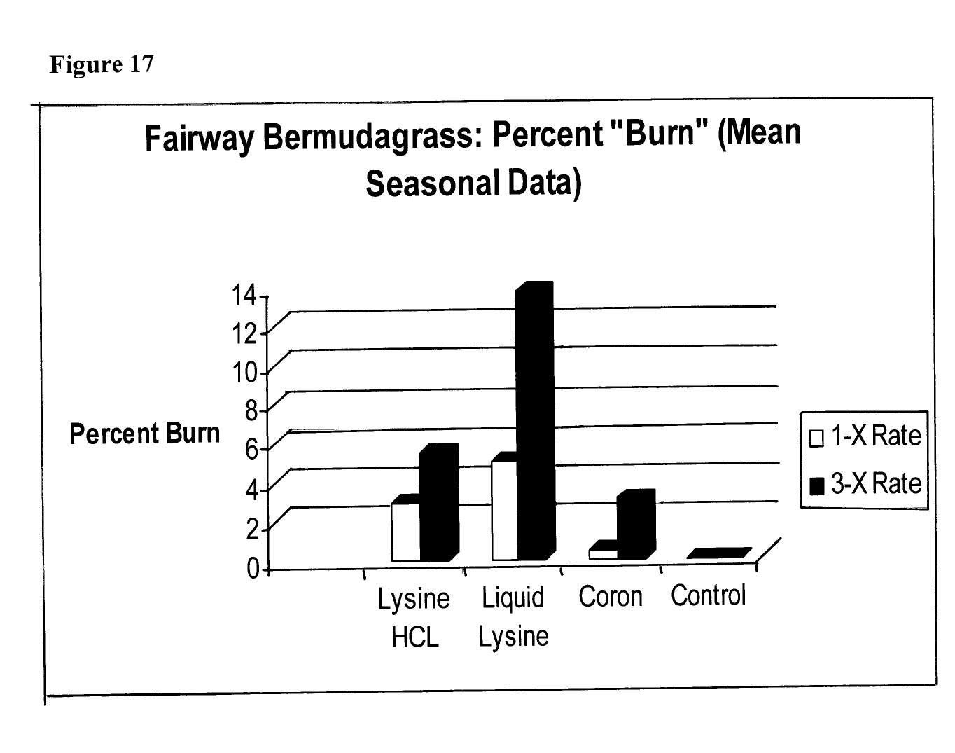

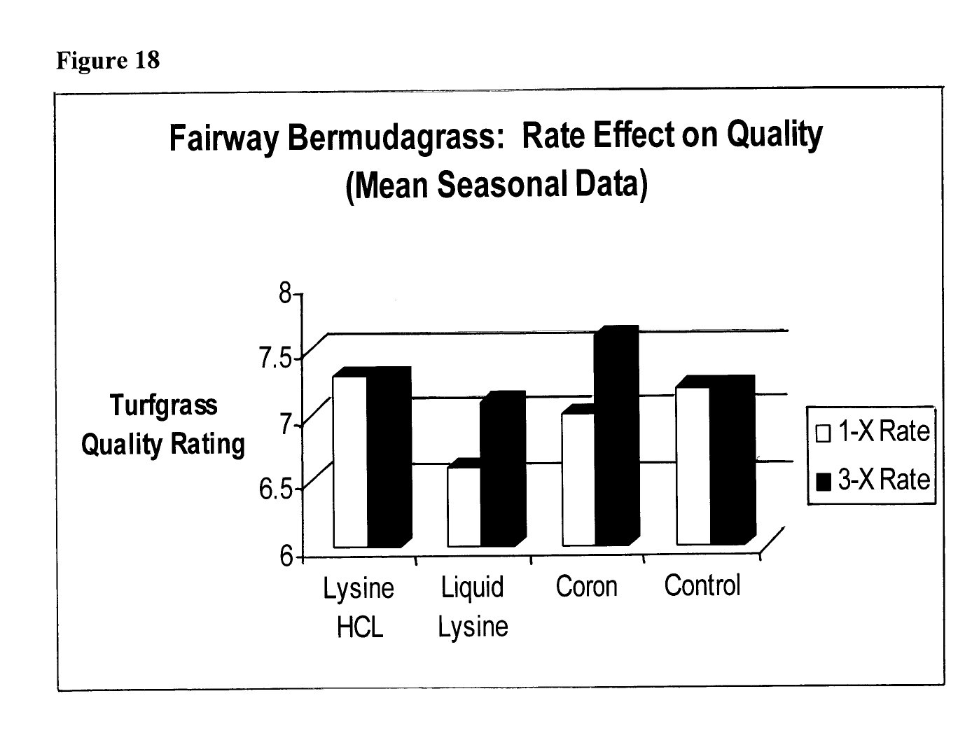

True foliar applications were studied with Bermuda grass in Fairways at the rates used in EXAMPLE 9. Results for mean data averaged over seven weeks for burn rate and turfgrass quality are presented in FIGS. 17 and 18, respectively. The results indicate that Bermuda grasses used on fairways is much more susceptible to burn as compared to lawn-type tall fescue. Lysine HCl had 3-5% burn levels depending upon the rate of application. Turfgrass quality ratings for liquid lysine and lysine HCl was better than Coron and control plots. The results also suggest that while liquid lysine and lysine HCl have a high burn potential, the turfgrasses recover quickly.

### Example 11

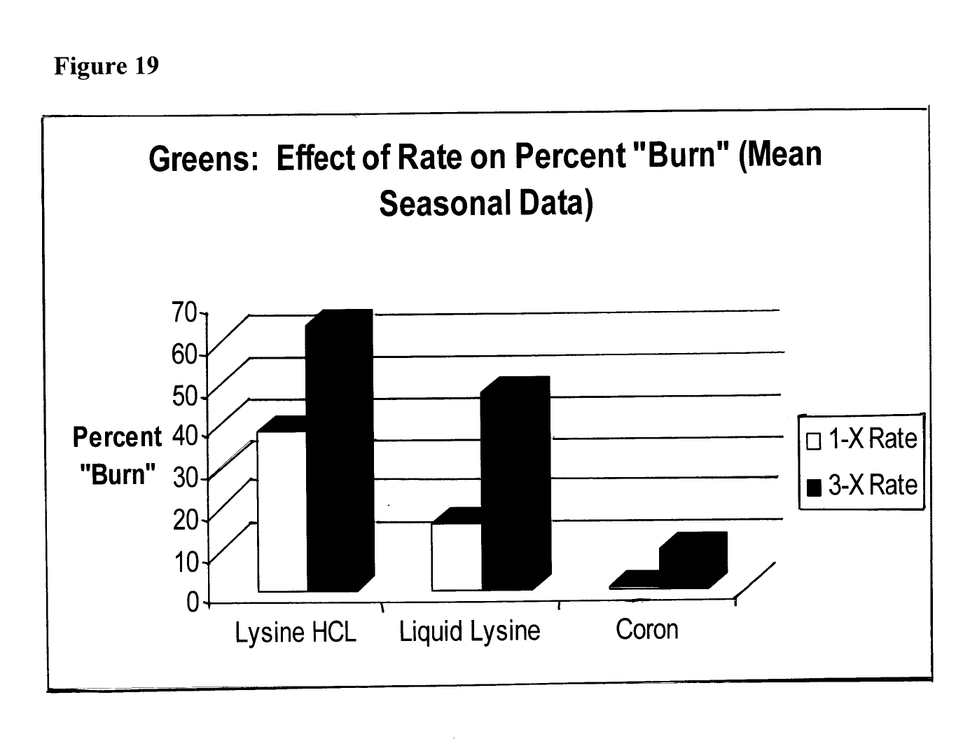

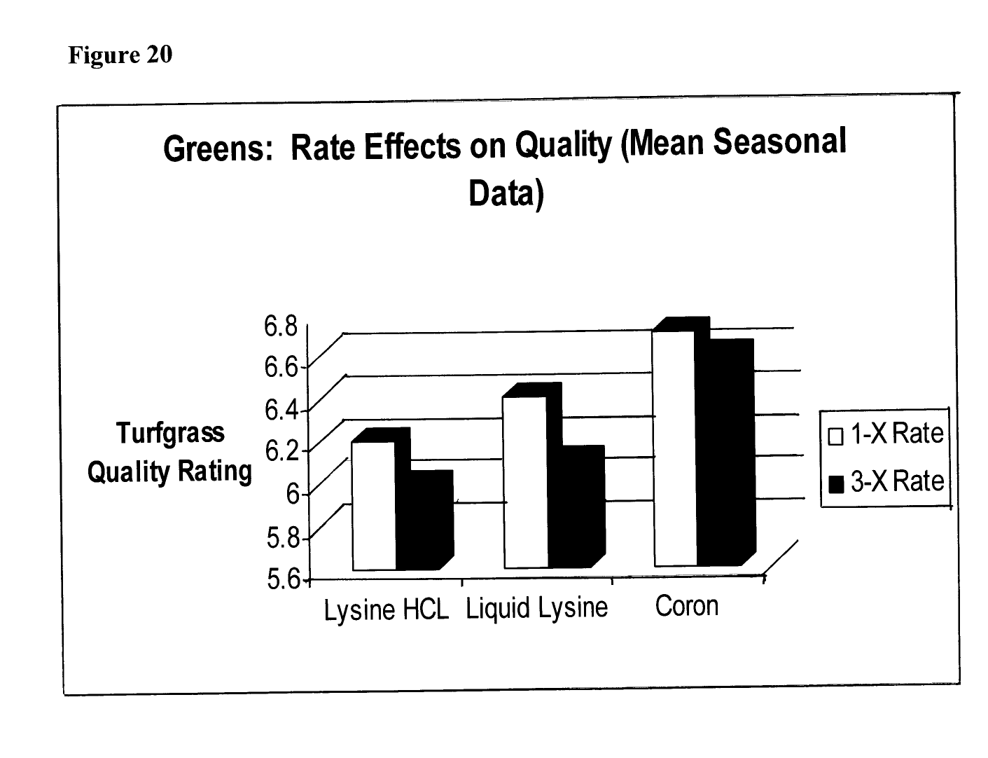

True foliar applications were studied with creeping bentgrass on greens and tees at the rates used in Example 9. Burn rates and turfgrass quality ratings averaged over a six week period are shown in FIGS. 19 and 20. Burn rates were found to be unacceptably high, but since typical foliar application rates are less than 5-30 times used here, the burn rates indicate the susceptibility of closely mown creeping bentgrasses compared to the fairway bermudagrass and tall fescues. Turfgrass quality ratings were found to be acceptable over the test period, with liquid lysine and lysine HCl providing statistically equal qualities as Coron.

### Example 12

A water soluble container is constructed. 5 lb Nitrogen as granular lysine HCl is stored in one bag, while 5 lb Nitrogen as liquid lysine is stored in another bag. The bags are added to a water tank containing 10,000 gallons of hard water. Sufficient mixing time is allowed for the bags to dissolve and the fertilizer compositions to mix in water. The prepared solution is spray applied to 100,000 sq ft of turf greens resulting in an application rate of 1.0 lb nitrogen per 1000 sq ft of greens.

### Example 13

Specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples. It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

1. A method comprising:
applying a lysine product to a turfgrass at a rate of at least 0.1 pounds of nitrogen per one thousand square feet of the turfgrass;
the nitrogen originating from the lysine product.

2. The method according to claim 1, the lysine product having a nitrogen content of at least 45%.

3. The method according to claim 1, wherein the lysine product is in a granular form.

4. The method according to claim 3, further comprising:
mixing the granular form of the lysine product with water, thus forming an aqueous solution; and
wherein applying the lysine product comprises spraying the aqueous solution on the turfgrass.

5. The method according to claim 3, wherein applying the lysine product comprises spreading the granular form of the lysine product on the turfgrass.

6. The method according to claim 1, wherein the turfgrass is selected from the group consisting of St. Augustine grass, Bermuda grass, dwarf Bermuda grass, tall fescue grass, bent grass, buffalo grass, rye grass, and combinations of any thereof.

7. The method according to claim 1, further comprising mixing the lysine product with an organic product selected from the group consisting of an animal manure, compost, bone meal, feather meal, blood meal, peat, and combinations of any thereof.

8. The method according to claim 1, further comprising mixing the lysine product with a compound selected from the group consisting of ammonium nitrate, ammonium sulfate, urea, potassium chloride, potash, ammonium phosphate, anhydrous ammonia, a phosphate salt, phosphorus, potassium, sulfur, iron, zinc, copper, magnesium, a fermentation cell broth, an ammonium salt of an organic acid, an amidated organic carboxylic acid, products and/or by-products generated at an agricultural product processing facility, a protein, a surfactant, an emulsifier, an antifoaming agent, a dispersant, a herbicide, an insecticide, a kelp extract, and combinations of any thereof.

9. The method according to claim 1, wherein the lysine product is selected from the group consisting of lysine monohydrochloride, lysine hydrate, lysine dihydrochloride, lysine sulfate, lysine free-base, lysine cell waste, lysine cell mass, lysine raffinate, a lysine mother liquor, and combinations of any thereof.

10. The method according to claim 1, wherein a nitrogen content of the lysine product is from 9-20%.

11. The method according to claim 1, further comprising:
placing the lysine product in a container comprising a water soluble material;
placing the container in water; and
agitating the container such that the container and the lysine product dissolves in the water.

12. A composition comprising:
a lysine product;
soil; and
an organic material.

13. The composition of claim 12, wherein the lysine product has a nitrogen content of at least 45%.

14. (canceled)

15. The composition of claim 12, wherein the lysine product is in a granular form.

16. The composition of claim 12, wherein the organic material is selected from the group consisting of animal manure, composted manure, compost, bone meal, feather meal, blood meal, peat, peat moss and combinations of any thereof.

17. The composition of claim 12, further comprising a compound selected from the group consisting of ammonium nitrate, ammonium sulfate, urea, potassium chloride, potash, ammonium phosphate, anhydrous ammonia, a phosphate salt, phosphorus, potassium, sulfur, iron, zinc, copper, magnesium, a fermentation cell broth, an ammonium salt of an organic acid, an amidated organic carboxylic acid, products and/or by-products generated at an agricultural product processing facility, a protein, 1 wetting agent, a surfactant, an emulsifier, an antifoaming agent, a dispersant, a herbicide, an insecticide, a kelp extract, and combinations of any thereof.

18. The composition of claim 12, wherein the lysine product is selected from the group consisting of lysine monohydrochloride, lysine hydrate, lysine dihydrochloride, lysine sulfate, lysine free-base, lysine cell waste, lysine cell mass, lysine raffinate, a lysine mother liquor, and combinations of any thereof.

19. The composition of claim 12, wherein a nitrogen content of the lysine product is from 9-20%.

20. A container comprising the composition of claim 12, the container comprising a water soluble material.

21. A method comprising:
applying a lysine product in a foliar application to a turfgrass at a rate of at least 0.1 pounds of nitrogen per one thousand square feet of the turfgrass;
the nitrogen originating from the lysine product.

22-23. (canceled)
